(19) United States
(12) Patent Application Publication
(10) Pub. No.: US 2025/0252245 A1
(43) Pub. Date: Aug. 7, 2025

(54) AUTOMATED DOCUMENT GENERATION IN ACCORDANCE WITH FORMATTING STYLES

(71) Applicant: INTERNATIONAL BUSINESS MACHINES CORPORATION, ARMONK, NY (US)

(72) Inventors: Jun Su, Beijing (CN); YANG LIANG, Beijing (CN); Su Liu, Austin, TX (US); MICHAEL DAVIS, Chesterfield, MO (US)

(21) Appl. No.: 18/431,639

(22) Filed: Feb. 2, 2024

(51) Int. Cl. G06F 40/103; G06F 40/194

(52) U.S. Cl. CPC G06F 40/103; G06F 40/194

(57) ABSTRACT

A process monitors contextual information of human-computer interactions (HCI) in a computing environment for reformatting formatted papers. The process integrates the monitored contextual information into a data structure via a formatting application. The process generates a paper that is formatted in accordance with predetermined formatting requirements of a publication, wherein the generated paper is uploaded to a page upload storage that stores the paper for the publication.

### BACKGROUND

Embodiments relate to a method, system, and computer program product that provide mechanisms for automated document generation in accordance with formatting styles.

Human-Computer Interaction (HCI) is a multidisciplinary field that focuses on the interaction between humans and computers. In the context of academic publishing and formatting tools, HCI plays a crucial role in enhancing the user experience. HCI analysis involves studying how users interact with a system and making improvements to enhance usability. In the context of paper or document format selection, HCI analysis may help ensure that the formatting tool is user-centered, accessible, and responsive to the needs of users. HCI analysis may also improve user interface design, provide user guidance, and make system enhancements based on user feedback.

Academic publishing is the process through which research findings and scholarly work are disseminated to the academic and scientific community. One of the primary forms of academic publication is the research paper, often published in academic journals. These papers are essential for sharing knowledge, contributing to scientific discourse, and advancing research in various fields. Many different types of formatting styles are used in different subjects in academic publishing. Such formatting styles include the American Psychological Association (APA) style, the Modern Language Association (APA) style, the Chicago style, the Institute of Electrical and Electronics Engineers (IEEE) style, the American Medical Association (AMA) style, etc. The different styles may impose different requirements. For example, documents in the IEEE style use a numerical citation format with square brackets for in-text citations, whereas documents in the AMA style use a numeric superscript format for in-text citations.

### SUMMARY

Provided are a method, system, and computer program product in which a process monitors contextual information of human-computer interactions (HCI) in a computing environment for reformatting formatted papers. The process integrates the monitored contextual information into a data structure via a formatting application. The process generates a paper that is formatted in accordance with predetermined formatting requirements of a publication, wherein the generated paper is uploaded to a page upload storage that stores the paper for publication.

In additional embodiments, the process selects a default format style of a paper processed according to monitored HCI contexts or user selection.

In further embodiments the process analyzes format styles of content including title, authors, abstract, background, problem discussion, experiment, discussion, conclusion, and reference list in the paper, wherein the paper is processed for editing or submitting the paper.

In certain embodiments, the process identifies a current format style in the paper.

In further embodiments, the process validates if the current format style of the paper is in compliance with selected format styles by comparing predicted format styles and identified format styles.

In additional embodiments, the process recommends a proper formatting style for correcting any invalid format styles including paper structure, layout, line space, font type and size, citation format, and reference orders.

In certain embodiments, the process provides a client application as a plug-in to a word processing application, wherein the client application interacts with a server application that reformats the paper.

### BRIEF DESCRIPTION OF THE DRAWINGS

Referring now to the drawings in which like reference numbers represent corresponding parts throughout:

FIG. 1 illustrates a block diagram of a computing environment, in accordance with certain embodiments.

FIG. 2 illustrates a flowchart that shows exemplary operations in accordance with certain embodiments.

FIG. 3 illustrates a block diagram that shows exemplary system components, in accordance with certain embodiments.

FIG. 4 illustrates a block diagram that shows operations performed by the system, in accordance with certain embodiments.

FIG. 5 illustrates a block diagram that shows examples of formatting style variations, in accordance with certain embodiments.

FIG. 6 illustrates a block diagram that shows how to detect the formatting style of a document, in accordance with certain embodiments.

FIG. 7 illustrates a block diagram that shows conversion from one format to another, in accordance with certain embodiments.

FIG. 8 illustrates a block diagram of a data structure that shows data changes in real-time, in accordance with certain embodiments.

FIG. 9 illustrates a flowchart that shows additional exemplary operations in accordance with certain embodiments.

FIG. 10 illustrates a computing environment in which certain components may be implemented, in accordance with certain embodiments.

### DETAILED DESCRIPTION

In the following description, reference is made to the accompanying drawings which form a part hereof and which illustrate several embodiments. It is understood that other embodiments may be utilized, and structural and operational changes may be made.

Authors, especially those new to academic publishing, often face challenges in adhering to the formatting guidelines of different journals. Ensuring that their papers meet these requirements can be time-consuming and sometimes be prone to error. Additionally, authors may need to adjust their papers when submitting to multiple journals with varying formatting styles.

Journal Paper Format refers to the specific set of guidelines, rules, and conventions that dictate how a scholarly or academic paper should be structured and presented when submitted for publication in a scientific, technical, or academic journal. This format encompasses a wide range of elements, including the layout, typography, citation style, headings, references, and overall organization of the paper. Authors are expected to adhere to these formatting requirements to ensure consistency and readability across all papers published in the journal. Adhering to a standardized format also helps facilitate the review process and ensures that the paper is presented in a manner that meets the expectations and standards of the scholarly community in a given field of study.

Scholars and researchers, when preparing and submitting their research papers to academic journals and conferences, often face significant challenges in adhering to the specific formatting and style guidelines of their target publications. Similar problems may occur in resume formats submitted for jobs, status reports, government forms, and legal documents.

The challenges for submitting research papers may include:
(1) Diverse Formatting Requirements: Different journals and conferences have their own unique formatting and style requirements. Authors may have to manually adjust their papers to meet the guidelines of each publication they submit to, leading to time-consuming and error-prone formatting processes.
(2) Formatting Errors: Authors may unintentionally introduce formatting errors, such as incorrect citation styles, inconsistent heading formats, or reference list discrepancies. These errors can lead to rejection or time-consuming revisions during the peer-review process.
(3) Inefficient Manual Formatting: Manual formatting is labor-intensive and distracts authors from focusing on the substance of their research. Authors may spend excessive time on formatting, which could be better used for research, analysis, and writing.
(4) Multiple Submissions: Researchers often submit their work to multiple journals and conferences to increase the chances of publication. This multiplies the effort required for manual formatting adjustments to meet the unique requirements of each target venue.
(5) Complexity of User Interaction: Existing formatting tools may lack user-friendly interfaces and real-time feedback mechanisms, making it difficult for authors to understand and control the formatting changes applied to their papers.

Certain embodiments provide an application referred to as a Journal Paper Formatting Assistant (JPFA) that is enabled with HCI (Human-Computer Interaction) analysis for minimizing the risk of formatting errors. The JPFA helps authors adapt to a wide range of formatting styles while catering to the specific requirements of different journals, conferences, and academic fields, and allows authors to efficiently prepare and submit their work to multiple journals and conferences with varying formatting guidelines. The JPFA ensures that received papers are consistently formatted and comply with the chosen or suggested formatting style in a receiver side, where the receiver side may comprise a server to which the formatted paper is uploaded.

Certain embodiments improve an automated formatting system implemented in a computing device by providing mechanisms to:
(1) Recommend editors to choose the right format style according to the contextual information in Human-Computer Interaction (HCI) level.
(2) Detect the formatting style of a given paper.
(3) Validate format style compliance of a given paper before submission and upload.
(4) Correct format style compliance issues in real-time.
(5) Convert format from one style to another.

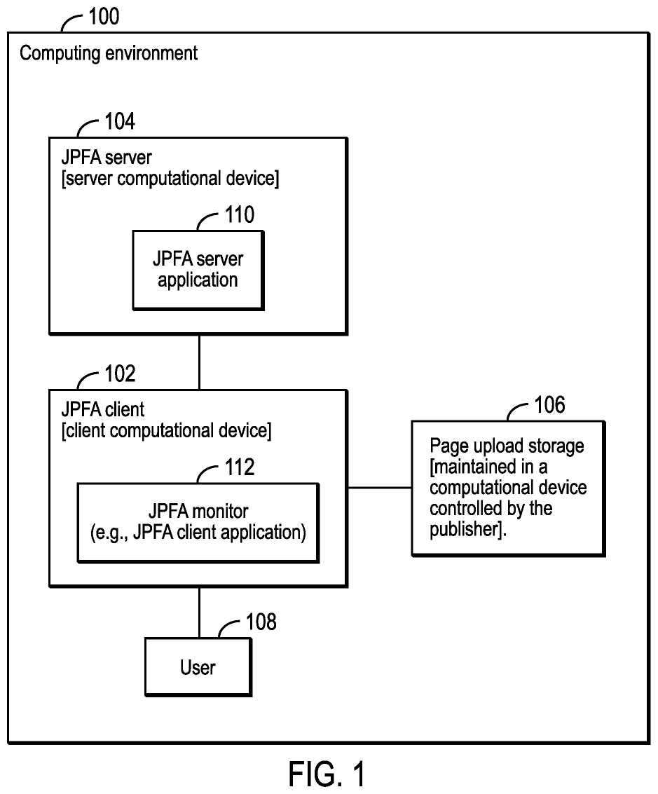

FIG. 1 illustrates a block diagram of a computing environment 100, in accordance with certain embodiments.

A JPFA client 102 is coupled to a JPFA server 104 and a page upload storage 106, where a user 108 interacts with the JPFA client 102.

The JPFA client 102 and the JPFA server 104 may in certain embodiments comprise any suitable computational device known in the art such as a server, a personal computer, a laptop, a telephony device, s mainframe, etc. The page upload storage 106 may be maintained in a computational device controlled by a publisher of a journal.

A JPFA server application 110 may execute in the JPFA server 104, and a JPFA monitor (e.g., a JPFA client application) 112 may execute in the JPFA client 102. The JPFA monitor 112 may be an add-on to existing document preparation application. The JPFA server application 110 and the JPFA monitor 112 may be implemented in same or separated hardware, firmware, software, or any combination thereof.

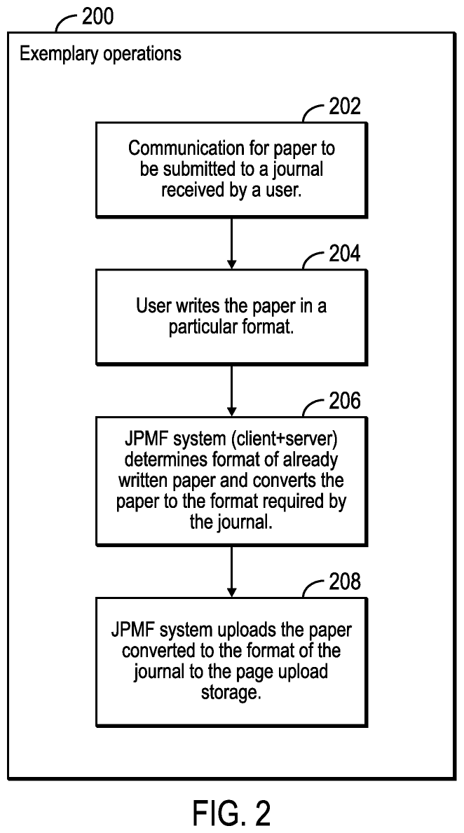

FIG. 2 illustrates a flowchart 200 that shows exemplary operations in accordance with certain embodiments.

Control starts at block 202 in which a communication for paper to be submitted to a journal received by a user. The user writes (at block 204) or may have already written the paper in a particular format. The JPFA system comprising the JPFA client 102 and the JPFA server 104 determines the format of the already written paper and converts the paper to the format required by the journal (at block 206).

From block 206 control proceeds to block 208 in which the JPFA system uploads the paper converted to the format of the journal to the page upload storage 106.

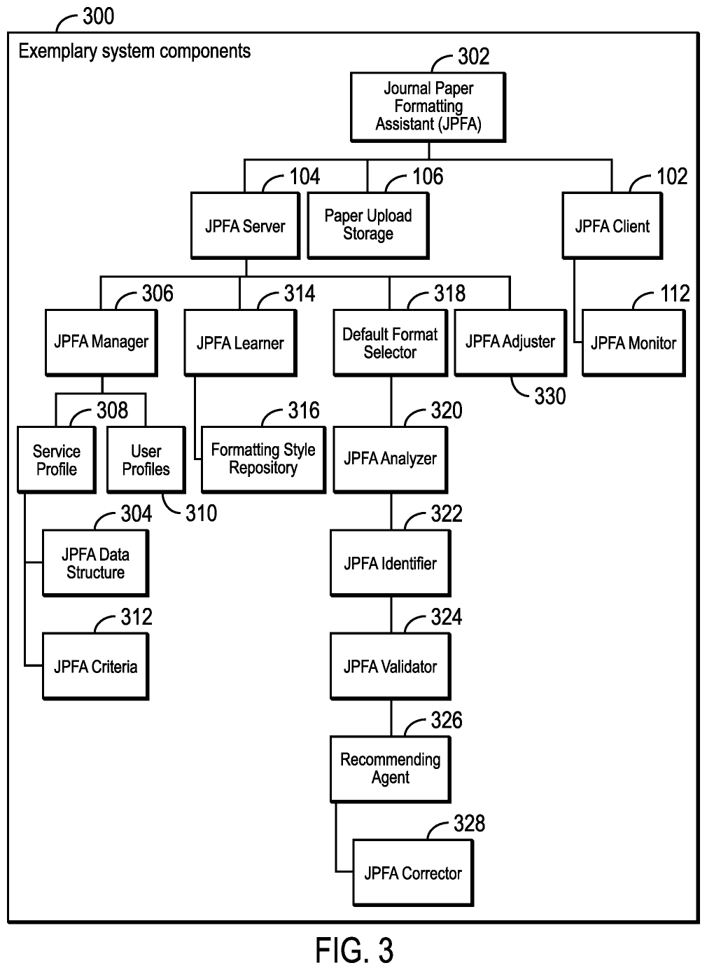

FIG. 3 illustrates a block diagram 300 that shows exemplary system components, in accordance with certain embodiments. In certain embodiments, the components 306, 314, 318, 330 may be part of the JPFA server application 110 shown in FIG. 1.

Certain embodiments define a JPFA 302 enabled with HCI Analysis for: (1) minimizing the risk of formatting errors; (2) helping authors adapt to a wide range of formatting styles; (3) catering to the specific requirements of different journals, conferences, and academic fields; (4) allowing authors to efficiently prepare and submit their work to multiple journals and conferences with varying formatting guidelines; and (5) ensuring received papers are consistently formatted and comply with the chosen or suggested formatting style in a receiver side.

Certain embodiments perform operations for performing a variety of tasks as described below.

Certain embodiments define a framework for supporting JPFA 302 to solve the focused problems [JPFA Server 104, JPFA-Client 102].

Certain embodiments define a JPFA Data Structure 304 for holding and tracking JPFA related attributes. For instance, JPFA_Data (UserID, SelectedStyle, CurrentStyle, Paper [UserID] [FileID] [SectionID] [StyleID], ComplianceStatus, Correction). [JPFA

### Data Structure 304].

Certain embodiments define a plugin and/or application which can be installed in online/offline paper editor (e.g., a Word Processor) level for editing a paper document with enabled JPFA features. [JPFA Client 102].

Certain embodiments allow users (e.g., administrators and non-administrator users) to configure and customize JPFA settings (enabled/disabled JPFA features), attributes of JPFA data structure, and JPFA criteria 312 [selected HCI data {input, output, applications}, formatting styles, auto-validation, auto-correction, auto-conversion mode]. [JPFA Manager 306, Service Profile 308, User Profiles 310, JPFA Criteria 312]. Certain embodiments provide mechanisms for learning formatting styles from guidelines, templates, submitted papers, and user confirmed styles. [JPFA Learner 314, Formatting Style Repository 316].

Certain embodiments provide mechanisms for monitoring contextual information of a user's human-computer interactions (e.g., reading a calling for paper email, accessing paper submission webpages, discussing research topic, searching paper/thesis/dissertation, writing/editing paper drafts, etc.). The monitored information may be integrated into the JPFA Data Structure via a JPFA client. [JPFA Monitor 112].

Certain embodiments provide mechanisms for selecting the default format style of a paper processed by the user according to the monitored HCI contexts or user selection. [Default Format Selector 318].

Certain embodiments provide mechanisms for analyzing the format styles of the content (title, authors, abstract, background, problem discussion, experiment, discussion, conclusion, reference list) in a paper processed by a user (editing or submitting) [JPFA Analyzer 320].

Certain embodiments provide mechanisms for identifying the current format style in the paper [JPFA Identifier 322].

Certain embodiments provide mechanisms for validating if the current format style of the paper is in compliance with the selected format styles (comparing the predicted format styles and identified format styles) [JPFA Validator].

Certain embodiments provide mechanisms for recommending a proper formatting style to the user for correcting any invalid format styles (paper structure, layout, line space, font type and size, citation format, reference orders etc.). [Recommending Agent 326].

Certain embodiments provide mechanisms for correcting and converting the incompliant format styles to the correct format styles accordingly to selected format styles and save it into Page Upload Storage 106. The correction and conversion operations are either triggered by the user instruction or the predefine JPFA criteria (auto-validation, auto-correction, auto-conversion mode) [JPFA Corrector 328].

Certain embodiments provide mechanisms for adjusting the JPFA criteria and settings according to the user feedback [JPFA Adjuster 330].

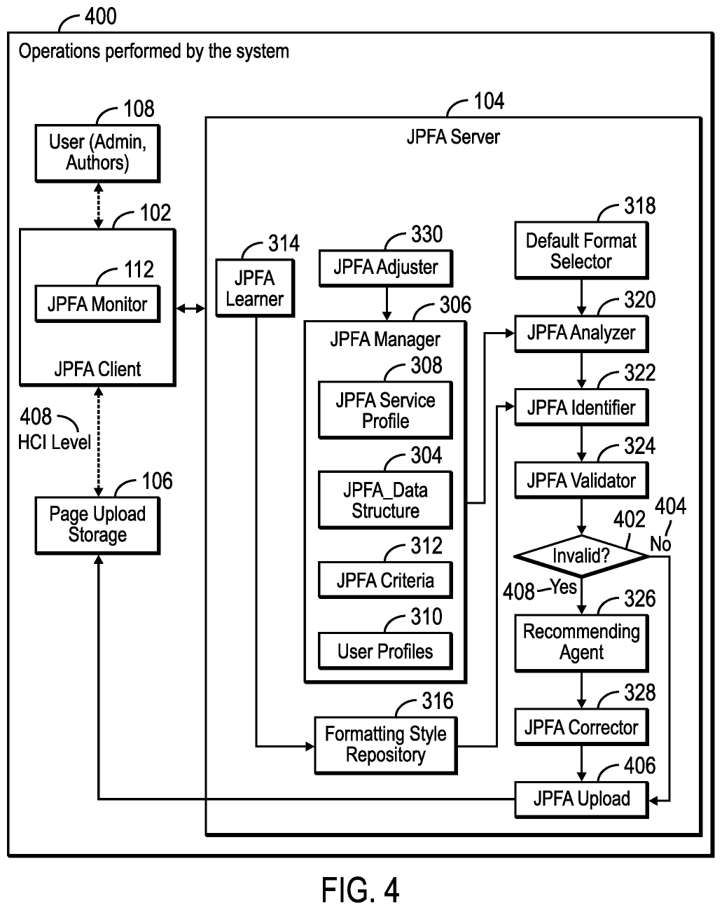

FIG. 4 illustrates a block diagram 400 that shows operations performed by the system, in accordance with certain embodiments.

The JPFA monitor 112 sends information to the JPFA learner 314, the JPFA adjuster 330, and the default format selector 318, where the information may include a paper whose format has to be identified and then converted to a format in accordance with a formatting style. The various components described earlier perform operations as described in earlier FIG. 3.

In FIG. 4 a determination is made by the JPFA validator 324 as to whether the current format style of the paper is in compliance with the selected format styles. If the format is not valid (block 402 and “No” branch 404) then a JPFA upload 406 process uploads the paper to the page upload storage 106. If the format is invalid (“Yes” branch 408) then control proceeds to the recommending agent 326 and then to the JPFA corrector 328 to format and correct the paper to convert the paper to be in compliance with the selected format styles and then the JPFA upload 406 uploads the converted paper to the page upload storage 106.

It may be noted that HCI level 408 interaction occurs between the JPFA client and the page upload storage 106 via the user 108. In certain embodiments, the components 306, 314, 318, 330 shown in FIG. 4 may be part of the JPFA server application 110 shown in FIG. 1.

In FIG. 4 it can be seen that the default format selector 318, the JPFA adjuster 330, and the JPFA learner 314 execute operations in parallel to reformat a paper in accordance with the formatting style required.

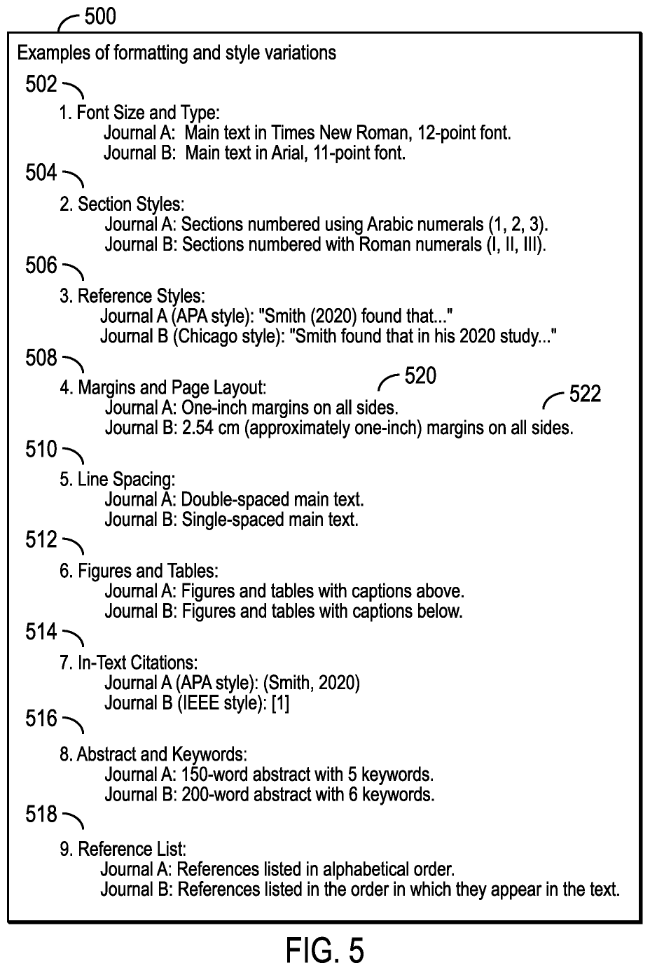

FIG. 5 illustrates a block diagram 500 that shows examples of formatting style variations, in accordance with certain embodiments. Nine different features and their formatting in two different styles of Journal A and Journal B are shown. The features relate to font size and type, section styles, reference styles, margins and page layout, line spacing, figures and tables, in-text citations, abstract and keywords, and reference lists (as shown via reference numeral 502, 504, 506, 508, 510, 512, 514, 516, 518).

The difference requirements for format styles for Journal A and Journal B are shown. For example, Journal A has one-inch margins on all sides and journal B has 2.54 cm (roughly 1 inch) margin on all sides as shown via reference numerals 520, 522.

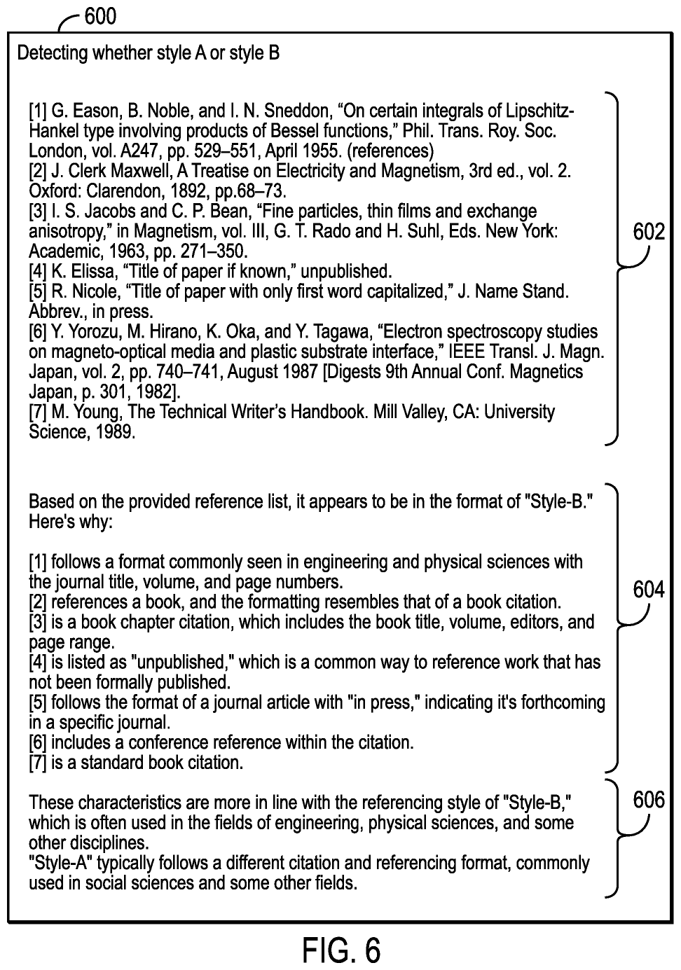

FIG. 6 illustrates a block diagram 600 that shows how to detect the formatting style of a document, in accordance with certain embodiments.

A reference list with 7 entries is shown via reference numeral 602 in FIG. 6. Based on the provided reference list a determination is made by analyzing the reference list to determine the formatting style of the documents. The characteristics of the document are determined and based on the characteristics the formatting style is determined to be in style-B as shown via reference numerals 604 and 606.

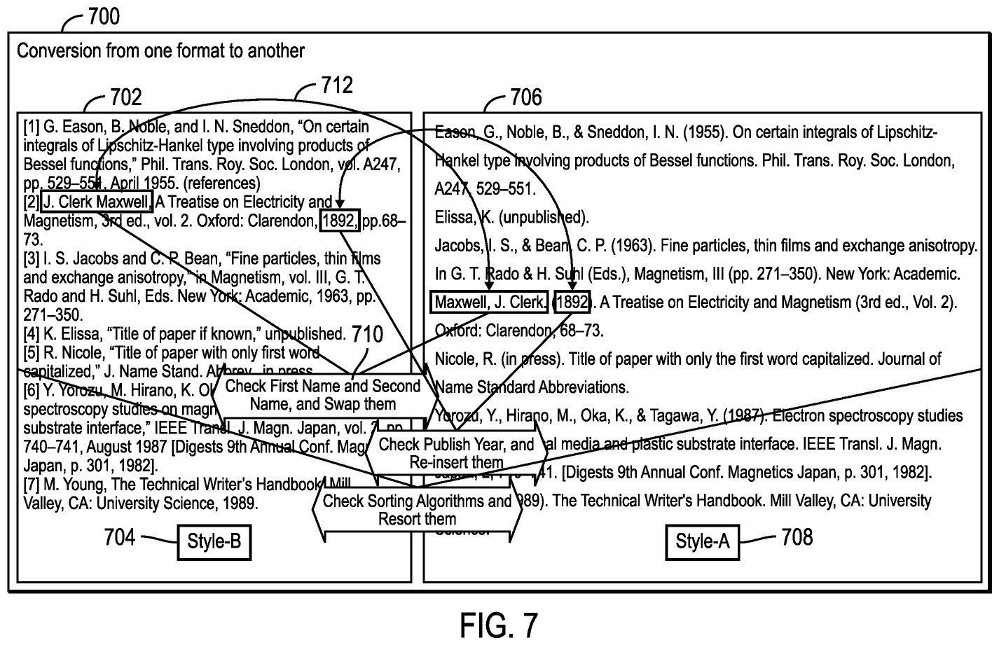

FIG. 7 illustrates a block diagram 700 that shows conversion from one format to another, in accordance with certain embodiments. The conversion of the reference list 702 which is in style-B 704 to a reference list 706 in style-A 708 is shown. For example, in style B the author names are written in the order of first and last name and this order is transposed in style A while reformatting the reference list 702 [as sown via reference numerals 710, 712).

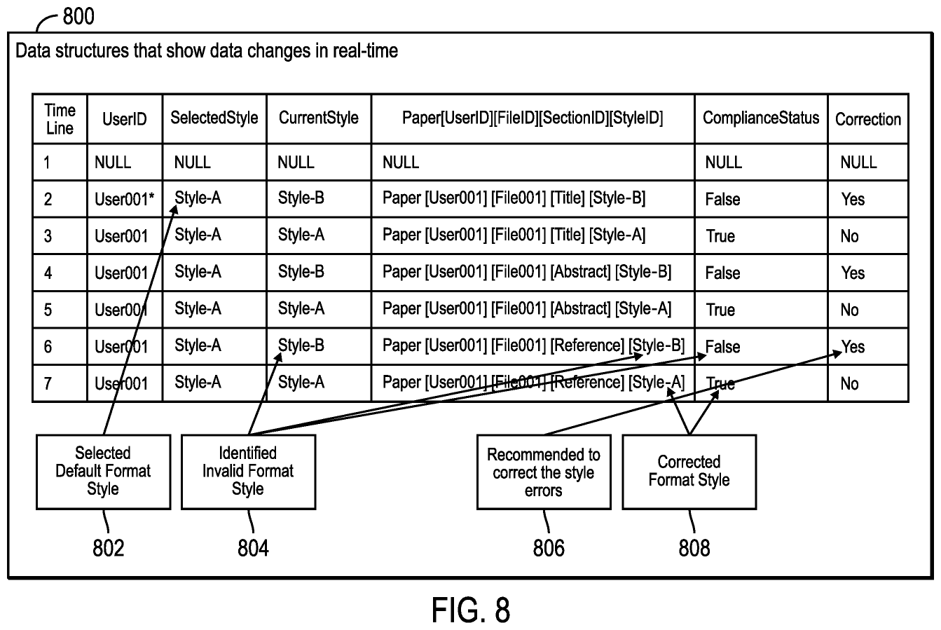

FIG. 8 illustrates a block diagram 800 of a data structure that shows data changes in real-time, in accordance with certain embodiments. Selected default format style, identified invalid format style, recommendation to correct the style errors, and corrected format styles at different times are shown via reference numerals 802, 804, 806, 808.

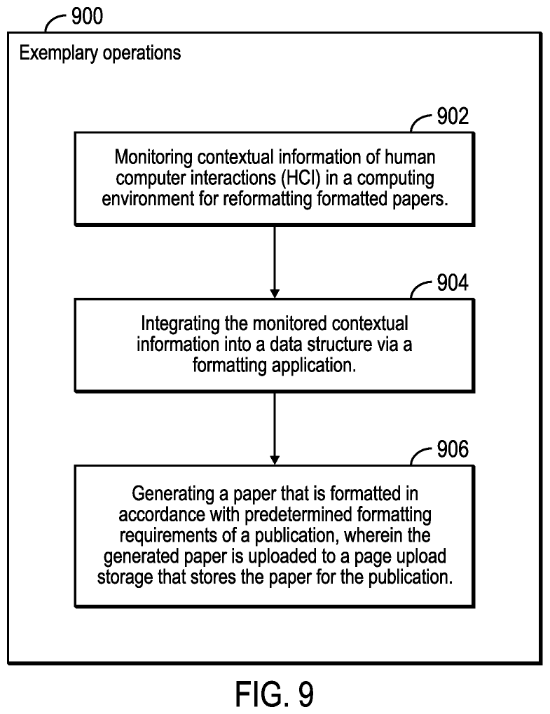

FIG. 9 illustrates a flowchart 900 that shows additional exemplary operations in accordance with certain embodiments.

Control starts at block 902 in which a process monitors contextual information of human-computer interactions (HCI) in a computing environment for reformatting formatted papers. The human-computer interactions may include reading a calling for paper email, accessing paper submission webpages, discussing over text a research topic, searching research papers, writing, or editing paper drafts, etc.

The process integrates (at block 904) the monitored contextual information into a data structure (e.g., JPFA data structure) via a formatting application (e.g., JPFA monitor). The process generates (at block 906) a paper that is formatted in accordance with predetermined formatting requirements of a publication, wherein the generated paper is uploaded to a page upload storage that stores the paper for publication.

Certain additional embodiments allow administrators and users to configure and customize JPFA settings (enabled/disabled JPFA features), attributes of JPFA data structure, and JPFA criteria (selected HCI data {input, output, applications}, formatting styles, auto-validation, auto-correction, auto-conversion mode). [JPFA Manager, Service Profile, User Profiles, JPFA Criteria]

Certain embodiments allow the learning of formatting styles from guidelines, templates, submitted papers, and user confirmed styles. [JPFA Learner, Formatting Style Repository].

Certain embodiments adjust the JPFA criteria and settings according to the user feedback [JPFA Adjuster].

Certain embodiments support a framework for supporting Journal Paper Formatting Assistant (JPFA) to solve focused problems [JPFA Server, JPFA-Client].

Certain embodiments define a JPFA Data Structure for holding and tracking JPFA related attributes. For instance, JPFA_Data (UserID, SelectedStyle, CurrentStyle, Paper [UserID] [FileID] [SectionID] [StyleID], ComplianceStatus, Correction) [JPFA Data Structure].

Certain embodiments define a plugin and/or application which can be installed in online/offline paper editor level for editing a paper document with enabled JPFA features. [JPFA Client].

Therefore, FIGS. 1-9 illustrate certain embodiments use the JPFA mechanism that integrates advanced technology, natural language processing, and human-computer interaction (HCI) analysis to simplify the paper formatting process. It starts by analyzing the context of user interactions, such as emails calling for papers, to suggest the appropriate formatting style. Users can confirm or modify the suggested style, making the system adaptable to their specific needs. The core component of the JPFA is an automated formatting engine that performs precise adjustments, ensuring compliance with the selected or suggested formatting style. Users can review and make manual adjustments as needed, supported by a user-friendly interface. The system collects user feedback and continuously improves the user experience through HCI analysis.

By automating the formatting process and enhancing user interaction, the JPFA streamlines the preparation of papers for submission, reducing errors and the time authors spend on formatting. These mechanisms not only improve the overall efficiency of academic publishing but also enhance the chances of successful submissions. The JPFA bridges the gap between scholarly research and publication, making the journey smoother and more user centered.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

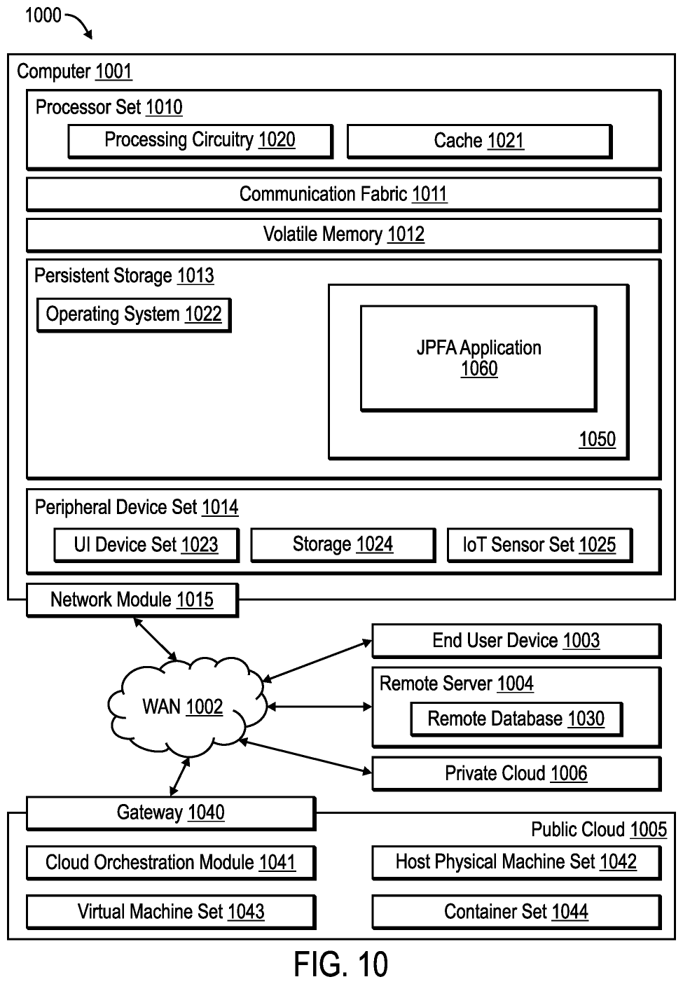

In FIG. 10 computing environment 1000 contains an example of an environment for the execution of at least some of the computer code (block 1050) involved in performing the operations of a JPFA application 1060 that may perform operations shown in FIGS. 1-9.

In addition to block 1050, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1050, as identified above), peripheral device set 1014 (including user interface (UI) device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible computer 1001 may be located in a cloud, even though it is not shown in a cloud in FIG. 8. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1050 in persistent storage 1013.

COMMUNICATION FABRIC 1011 is the signal conduction path that allows the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, volatile memory 1012 is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid-state storage devices. Operating system 1022 may take several forms, such as various known proprietary operating systems or open-source Portable Operating System Interface-type operating systems that employ a kernel. The code included in block 1050 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. I/O T sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN 1002 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

The letter designators, such as i, is used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A method, comprising:
monitoring contextual information of human-computer interactions (HCI) in a computing environment for reformatting formatted papers;
integrating the monitored contextual information into a data structure via a formatting application; and
generating a paper that is formatted in accordance with predetermined formatting requirements of a publication, wherein the generated paper is uploaded to a page upload storage that stores the paper for the publication.

2. The method of claim 1, the method further comprising:
selecting a default format style of a paper processed according to monitored HCI contexts or user selection.

3. The method of claim 1, the method further comprising:
analyzing format styles of content including title, authors, abstract, background, problem discussion, experiment, discussion, conclusion, and reference list in the paper, wherein the paper is processed for editing or submitting the paper.

4. The method of claim 1, the method further comprising:
identifying a current format style in the paper.

5. The method of claim 4, the method further comprising:
validating if the current format style of the paper is in compliance with selected format styles by comparing predicted format styles and identified format styles.

6. The method of claim 1, the method further comprising:
recommending a proper formatting style for correcting any invalid format styles including paper structure, layout, line space, font type and size, citation format, and reference orders.

7. The method of claim 1, the method further comprising:
providing a client application as a plug-in to a word processing application, wherein the client application interacts with a server application that reformats the paper.

8. A system, comprising:
a memory; and
a processor coupled to the memory, wherein the processor performs operations, the operations comprising:
monitoring contextual information of human-computer interactions (HCI) in a computing environment for reformatting formatted papers;
integrating the monitored contextual information into a data structure via a formatting application; and
generating a paper that is formatted in accordance with predetermined formatting requirements of a publication, wherein the generated paper is uploaded to a page upload storage that stores the paper for the publication.

9. The system of claim 8, the operations further comprising:
selecting a default format style of a paper processed according to monitored HCI contexts or user selection.

10. The system of claim 8, the operations further comprising:
analyzing format styles of content including title, authors, abstract, background, problem discussion, experiment, discussion, conclusion, and reference list in the paper, wherein the paper is processed for editing or submitting the paper.

11. The system of claim 8, the operations further comprising:
identifying a current format style in the paper.

12. The system of claim 11, the operations further comprising:
validating if the current format style of the paper is in compliance with selected format styles by comparing predicted format styles and identified format styles.

13. The system of claim 8, the operations further comprising:
recommending a proper formatting style for correcting any invalid format styles including paper structure, layout, line space, font type and size, citation format, and reference orders.

14. The system of claim 8, the operations further comprising:
providing a client application as a plug-in to a word processing application, wherein the client application interacts with a server application that reformats the paper.

15. A computer program product, the computer program product comprising a computer readable storage medium having computer readable program code embodied therewith, the computer readable program code when executed is configured to perform operations, the operations comprising:
monitoring contextual information of human-computer interactions (HCI) in a computing environment for reformatting formatted papers;
integrating the monitored contextual information into a data structure via a formatting application; and
generating a paper that is formatted in accordance with predetermined formatting requirements of a publication, wherein the generated paper is uploaded to a page upload storage that stores the paper for the publication.

16. The computer program product of claim 15, the operations further comprising:
selecting a default format style of a paper processed according to monitored HCI contexts or user selection.

17. The computer program product of claim 15, the operations further comprising:
analyzing format styles of content including title, authors, abstract, background, problem discussion, experiment, discussion, conclusion, and reference list in the paper, wherein the paper is processed for editing or submitting the paper.

18. The computer program product of claim 15, the operations further comprising:
identifying a current format style in the paper.

19. The computer program product of claim 18, the operations further comprising:
validating if the current format style of the paper is in compliance with selected format styles by comparing predicted format styles and identified format styles.

20. The computer program product of claim 15, the operations further comprising:
recommending a proper formatting style for correcting any invalid format styles including paper structure, layout, line space, font type and size, citation format, and reference orders.
